(19) United States
(12) Patent Application Publication
(10) Pub. No.: US 2025/0173522 A1
(43) Pub. Date: May 29, 2025

(54) TRANSLATION MODEL TRAINING METHOD, TRANSLATION METHOD, DEVICE, ELECTRONIC EQUIPMENT, AND MEDIUM

(71) Applicant: Hangzhou Alibaba International Internet Industry Co., Ltd., Hangzhou (CN)

(72) Inventors: Ben Chen, Hangzhou (CN); Kaidi Chen, Hangzhou (CN); Huangyu Dai, Hangzhou (CN)

(21) Appl. No.: 18/918,767

(22) Filed: Oct. 17, 2024

(30) Foreign Application Priority Data
Nov. 23, 2023 (CN) 202311578680.0

(51) Int. Cl. G06F 40/42

(52) U.S. Cl. CPC G06F 40/42

(57) ABSTRACT

The present application provides a translation model training method, translation method, device, electronic equipment, and medium, relating to the field of translation model technology. The translation model training method includes: expanding vocabulary of the translation model with commonly used vocabulary and specialized vocabulary in advance, optimizing feature vectors in the vocabulary based on a large language model, cleaning an open-source dataset using a data cleaning method to filter and retain corpora meeting a quality standard, and training the translation model using filtered corpora. The translation method includes: obtaining source language text to be translated, inputting the source language text into a translation model to obtain target language text after translation. The embodiments of this application not only enhance the vocabulary of the translation model but also improve the accuracy of the translation model in specialized domains.

### CROSS-REFERENCE TO RELATED APPLICATIONS

This application claims priority to Chinese Patent Application 202311578680.0, filed with the China National Intellectual Property Administration on Nov. 23, 2023, and entitled “Translation Model Training Method, Translation Method, Device, Electronic Equipment, and Medium,” which is incorporated herein by reference in its entirety.

### TECHNICAL FIELD

This application relates to the technical field of translation models, and more particularly to a translation model training method, a translation method, a device, electronic equipment, and a medium.

### BACKGROUND

Cross-border e-commerce platforms typically serve multiple countries and involve various languages. As a crucial component of cross-border e-commerce platforms, translation is primarily used to convert non-target languages into target languages, facilitating user comprehension and usability. This has a direct impact on service conversion and user experience.

Currently, there are two commonly used types of translation models: specialized translation models and general large language models (LLMs). Specialized translation models utilize an encode-decode architecture and are trained with a large amount of open-source data, yielding better results in cross-lingual translation. General LLMs, on the other hand, adopt a decode-only architecture, trained on datasets from various domains, with lower computational complexity and better robustness in translating different types of text. However, specialized translation models have high computational complexity and perform poorly in translating specialized vocabulary. General LLMs, while large in scale and resource-intensive, are often difficult to implement in real-world experiments and tend to underperform in vertical domains compared to specialized translation models.

### SUMMARY

The embodiments of this application provide a translation model training method, a translation method, a device, electronic equipment, and a medium to improve the accuracy of translation models in specialized domain translations.

In a first aspect, the embodiments of this application provide a translation model training method, which includes:
expanding vocabulary of the translation model with commonly used vocabulary and specialized vocabulary in advance;
optimizing feature vectors in the vocabulary based on a large language model;
cleaning an open-source dataset using a data cleaning method to filter and retain corpora meeting a quality standard; and
training the translation model using filtered corpora.

In a second aspect, the embodiments of this application provide a translation method, which includes:
obtaining source language text to be translated;
inputting the source language text into a translation model to obtain target language text after translation;
wherein the translation model is trained using the aforementioned translation model training method.

In a third aspect, the embodiments of this application provide a translation model training device, which includes:
an expansion module, configured to expand vocabulary of the translation model with commonly used vocabulary and specialized vocabulary in advance;
an optimization module, configured to optimize feature vectors in the vocabulary based on a large language model;
a cleansing module, configured to clean an open-source dataset using a data cleansing method to filter and retain corpora meeting a quality standard;
a training module, configured to train the translation model using filtered corpora.

In a fourth aspect, the embodiments of this application provide a translation device, which includes:
an acquisition module, configured to obtain source language text to be translated;
a translation module, configured to input the source language text into the translation model and obtain the target language text after translation;
wherein the translation model is trained using the aforementioned translation model training method.

In a fifth aspect, the embodiments of this application provide an electronic device, comprising a memory, a processor, and a computer program stored in the memory, wherein the processor, when executing the computer program, is configured to implement any of the methods described above.

In a sixth aspect, the embodiments of this application provide a computer-readable storage medium, in which a computer program is stored. When executed by a processor, the computer program is configured to implement any of the methods described above.

Compared with the prior art, this application has the following advantages:
by expanding the vocabulary of the translation model in advance with commonly used vocabulary and specialized vocabulary, optimizing the feature vectors in the vocabulary based on a large language model, and using data cleansing methods to filter open-source datasets to obtain corpora that meet quality requirements, the translation model is trained with these corpora. This not only expands the model's vocabulary but also enhances its accuracy in specialized domain translations.

The above description is merely an overview of the technical solutions of this application. To gain a clearer understanding of the technical means of this application, the contents of the specification may be implemented accordingly. Furthermore, to make the above and other objectives, features, and advantages of this application more apparent and understandable, specific embodiments of this application are provided below.

### BRIEF DESCRIPTION OF THE DRAWINGS

In the drawings, unless otherwise specified, the same reference numerals throughout the various figures indicate the same or similar components or elements. These drawings are not necessarily drawn to scale. It should be understood that these drawings depict only some embodiments of this application and should not be considered as limiting the scope of the application.

FIG. 1 is a schematic diagram of an application scenario of the translation method provided by this application;

FIG. 2 is a flowchart of the translation model training method according to one embodiment of this application;

FIG. 3 is a flowchart of the translation model training method according to another embodiment of this application;

FIG. 4 is a schematic diagram of using an LLM to output specialized vocabulary in a designated domain according to another embodiment of this application;

FIG. 5 is a schematic diagram of the translation model training process according to another embodiment of this application;

FIG. 6 is a flowchart of the translation method according to another embodiment of this application;

FIG. 7 is a structural block diagram of the translation model training device according to another embodiment of this application;

FIG. 8 is a structural block diagram of the translation device according to another embodiment of this application;

FIG. 9 is a block diagram of the electronic device used to implement embodiments of this application.

### DETAIL DESCRIPTION OF THE EMBODIMENTS

In the following, certain exemplary embodiments are simply described. As those skilled in the art will recognize, the described embodiments can be modified in various ways without departing from the spirit or scope of this application. Therefore, the drawings and descriptions are considered illustrative in nature rather than restrictive.

To facilitate the understanding of the technical solutions in the embodiments of this application, the relevant technologies of the embodiments are explained below. These related technologies, as optional solutions, can be combined with the technical solutions of the embodiments of this application in any manner, all of which fall within the scope of protection of the embodiments of this application.

Firstly, the terms involved in this application are explained.

BLEU: a translation evaluation metric that focuses on accuracy and fluency, used to assess the similarity between two translated sentences. It can be divided into four types: BLEU-1, BLEU-2, BLEU-3, and BLEU-4, based on n-grams, where n-grams refer to a sequence of n consecutive words. BLEU-1 measures word-level accuracy, while the other three higher-order BLEU scores evaluate sentence fluency.

ROUGE: a translation evaluation metric that focuses on recall rate and considers common subsequences between machine translations and reference translations. It is used to assess the similarity between translated sentences and target sentences. The higher the ROUGE score, the more similar the translation is to the target, indicating better translation quality.

Multilingual Sites: e-commerce websites where the display language is a non-English search platform, such as Japanese, German, French, and Spanish versions of an e-commerce site.

Robustness: a measure of the stability of model performance, representing the model's ability to perform under varying data distributions and different types of interference.

LLM (Large Language Model): refers to deep learning models trained on large amounts of textual data, capable of generating natural language text or understanding the meaning of language. LLMs can handle various natural language tasks, such as text classification, question answering, and conversation, and are an important pathway toward artificial intelligence.

The translation model training method and translation method provided by the embodiments of this application can be applied to any electronic device, including but not limited to: computers, mobile terminals, tablet computers, laptops, or servers. The specific application scenarios can vary, including but not limited to multilingual product search translation scenarios or conversation translation scenarios on e-commerce platforms. The translation model involves multiple languages, with no specific limit on the number of languages, such as Chinese, English, French, Italian, Arabic, Thai, Hindi, Hebrew, Portuguese, Japanese, Korean, Swedish, Polish, or Danish. Any of these languages can serve as the source or target language in the translation model.

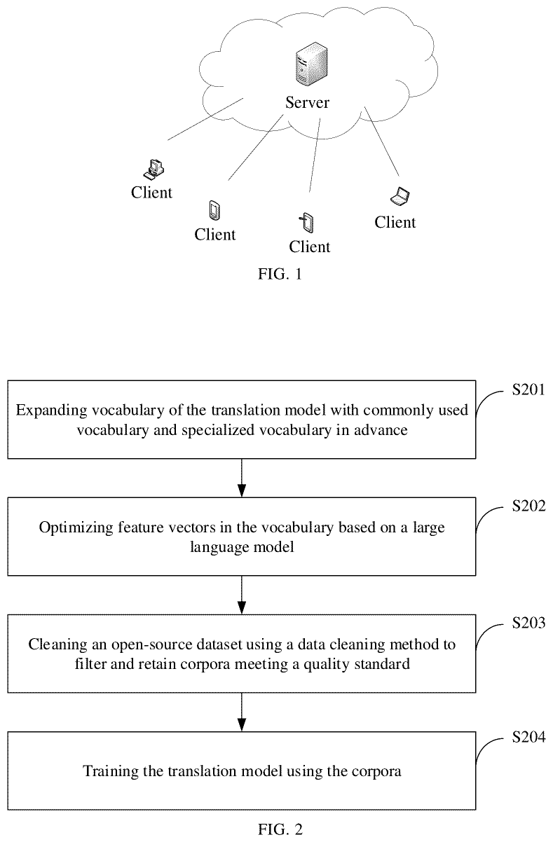

The translation method provided by the embodiments of this application can also be applied to cloud-based electronic devices. FIG. 1 is a schematic diagram of an exemplary application scenario for implementing the translation method of this application. When a client generates a translation request during service usage, the cloud server performs the translation using the aforementioned translation method, and based on the translation result, provides the corresponding service to the client. The cloud server can provide cloud application-related services to multiple clients. The client types can vary, including computers, mobile phones, tablets, or laptops. The cloud server can be deployed as needed, either in a centralized or distributed manner. For example, multiple servers can be deployed in the cloud, with each server providing a cloud application, or a single server can be deployed to provide multiple cloud applications simultaneously. The diagram illustrates a single-server deployment as an example.

The embodiments of this application provide a translation model training method, as shown in FIG. 2, which is a flowchart of the translation model training method according to one embodiment of this application. The method may include the following steps.

S201: expanding vocabulary of the translation model with commonly used vocabulary and specialized vocabulary in advance.

In the embodiments of this application, the translation model refers to a model used for multilingual translation, specifically using an encode-decode architecture. The translation model stores a pre-configured vocabulary, which serves as the basis for translation. Since multiple languages are involved, multiple vocabularies are typically configured, with each vocabulary used for translating from one language to another. For multilingual translation, a corresponding vocabulary can be configured for any two languages. The vocabulary includes at least an ID, source language text, target language text, and feature vectors. The feature vectors, represented in vector form, are used to characterize the semantic understanding of words, and the accuracy of the feature vectors reflects the accuracy of translation from the source language to the target language.

Common vocabulary refers to words that are frequently used in daily communication within a particular language, meaning words that are commonly encountered. For example, there are approximately 7,000 common words in Chinese. Expanding the common vocabulary involves increasing the number of common words in the vocabulary list, such as increasing from 2,000 to 6,000 words. Expanding the specialized vocabulary in the vocabulary list may include adding at least one of the following: proprietary brand terms, geographical terms, culturally specific terms, e-commerce-specific terms, or English exam vocabulary.

S202: optimizing feature vectors in the vocabulary based on a large language model.

In one embodiment, the above step S202 may include: inputting a query into the LLM (Large Language Model), which processes the query and outputs specialized vocabulary for a specified domain. The specialized vocabulary is then used to refine the feature vectors in the vocabulary.

The aforementioned large language model may include at least one of the following: BLOOMZ (Autoregressive Model), GPT (Generative Pre-Trained Transformer, a generative pre-training model based on the Transformer architecture) 4, ChatGLM (General Language Model), LLAMA (Large Language Model Meta AI), OPT (Open Pretrained Transformer), the Claude model, Qwen, or ERNIE Bot, among others.

S203: cleaning an open-source dataset using a data cleaning method to filter and retain corpora meeting a quality standard.

In the embodiments of this application, data cleansing method refer to techniques for filtering the dataset to obtain data that meets the required standards. These methods include, but are not limited to: the CL-SSL (Cross Lingual-Semantic Similarity Learning) method, the LASER (Language-Agnostic Sentence Representations) method, the Length method, the LID (Language Identification) method, Deduplication methods, or the Retranslation Filter method, among others.

In one embodiment, step S203 may include at least one of the following:

Using the CL-SSL method to clean the open-source dataset, filtering out corpora with semantic similarity above a threshold; using the LASER method to clean the open-source dataset, filtering out corpora with sentence embedding similarity above a threshold; using the Length method to clean the open-source dataset, filtering out corpora where the maximum and minimum sentence length ratios meet the threshold; using the LID (Language Identification) method to clean the open-source dataset, filtering out corpora that match the source and target languages; using the Deduplication method to clean the open-source dataset by removing duplicate data; and using the Retranslation Filter method to clean the open-source dataset, filtering out corpora that meet translation metrics.

S204: training the translation model using the aforementioned corpora.

In one embodiment, step S204 may include:
training the translation model using the corpora with a specified method, where the specified method may include at least one of the following: contrastive learning, supervised learning, reinforcement learning, semi-supervised learning, weakly supervised learning, or self-supervised learning.

In one embodiment, the method may further include: using a hybrid deduplication method or a model training and prediction-based deduplication method to perform deduplication optimization on the translation results during the training process.

The translation model training method provided by this embodiment expands the translation model's vocabulary by adding commonly used and specialized vocabulary in advance, optimizes the feature vectors in the vocabulary based on a large language model, and uses data cleansing methods to clean open-source datasets, filtering out high-quality corpora. By training the translation model with these corpora, the method not only expands the vocabulary but also improves the accuracy of the translation model in specialized domain translations.

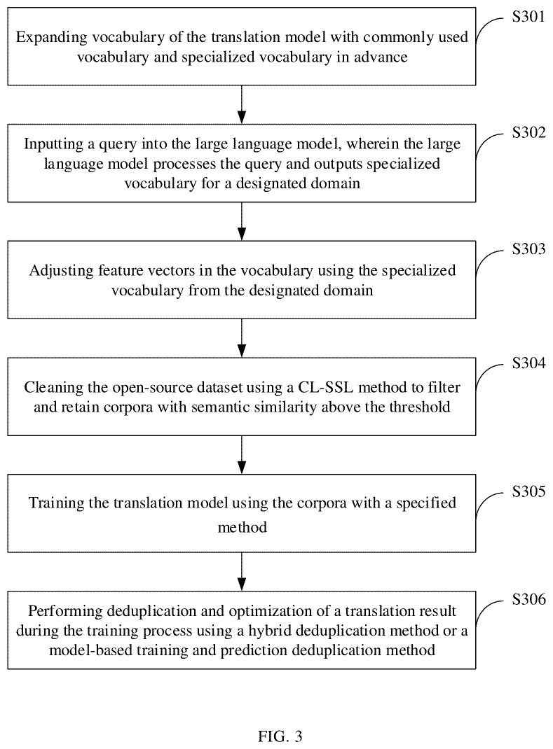

The embodiments of this application further provide a translation model training method, as shown in FIG. 3, which is a flowchart of the translation model training method according to another embodiment of this application. The method may include the following steps.

S301: expanding vocabulary of the translation model with commonly used vocabulary and specialized vocabulary in advance.

In the embodiments of this application, the translation model involves multiple languages. When expanding the vocabulary, each vocabulary configured for the translation model can be expanded, ensuring that the vocabulary corresponding to any two languages is increased, thereby enhancing the overall vocabulary size.

For example, the common Chinese vocabulary typically includes around 7,000 words. If the current translation model only covers 2,575 Chinese words, an additional 4,427 Chinese words can be added, significantly expanding the vocabulary and thereby improving the translation accuracy of the model. Table 1 below provides a simple example of some words and their corresponding IDs in the vocabulary.

| Chinese | | Chinese | | Chinese | |
|---|---|---|---|---|---|
| Word | ID | Word | ID | Word | ID |
| Chicken | 260494 | Duck | 260505 | Goose | 260528 |
| Pigeon | 260520 | Turtle | 260628 | Mushroom | 259124 |
| Chrysanthemum | 259125 | Porcelain | 258213 | Bend/Curved | 257044 |
| Temple | 257017 | Curtain | 256992 | Comb | 257515 |
| Fence/ | 257471 | Lemon | 257464 | Pomelo/ | 257461 |
| Railing | | | | Grapefruit | |

Before the vocabulary expansion, the translation model may fail to provide correct translations for the Chinese words “ [symbol] (Chicken, Duck, Goose)” and might generate an incorrect translation. However, after the vocabulary expansion, the model can correctly recognize these three words and provide accurate translations, as shown in Table 2.

TABLE 2

| | Translation Model | Translation Model |
|---|---|---|
| Translation Vocabulary | Before Expansion | After Expansion |
| Chicken, duck, goose | Polyester | Chicken, duck, goose |

The expanded specialized vocabulary may include at least one of the following: proprietary brand names, geographical terms, culturally specific terms, e-commerce-specific terms, or English exam vocabulary. For example, e-commerce-specific terms such as drop shipping, Gua sha, or knee-length shorts; and English exam terms such as CET-4, CET-6, IELTS, TOEFL, or TOEIC. An example is shown in Table 3. By adding website brand names, Chinese geographical and cultural terms, and e-commerce-specific terminology, the model achieves accurate brand translation, avoids errors in Chinese geographical and cultural terms, and precisely expresses specialized vocabulary.

TABLE 3

| | | E-commerce |
|---|---|---|
| Website Brand | Chinese Geographical | Specific |
| Names | and Cultural Terms | Terms |
| Fengquan | Yellow River | backless |
| Weifa | Pearl River | camisole |
| JVTE | Liao River | pullover |
| Ziyi | Hai River | streetwear |
| Lvxinyuan | Huai River | eye shadow |
| Jinbang | Yalu River | rose |
| Jinlun | Han River | lipstick |
| Ronghua | Mekong River | moisturizing |
| Oetiker | Jialing River | whitening |
| Angle Grinder | Hulun Buir River | outlining |
| DUET | Poyang Lake | flawless |
| OUDU | Dongting Lake | smudged |
| Milwaukee | Tai Lake | Cappuvini |
| Topline Consulting | Qinghai Lake | magnetic |
| Hongxi | South-to-North Water | not fading |
| ISCAR | Transfer Project | not fading |
| SUMITOMO | Qiantang River | not Fading |
| IRWIN joran | Holin River | not Fading |
| KENNAMETAL | Kunming Lake | dose not take off |
| | | makeup |
| AKEN | West Lake | hydrating |
| Elcometer | Grand Canal | Moisturizing |
| JACKLY | Lake Baikal | light and thin |
| | Sea of Okhotsk | nourishing skin |
| | Karst Topography | oil Control |

S302: inputting a query into the large language model, wherein the large language model processes the query and outputs specialized vocabulary for a designated domain.

The aforementioned large language models may include at least one of the following: BLOOMZ, GPT-4, ChatGLM, LLaMA, OPT, Claude, Qwen, or ERNIE Bot. The specialized terminology provided by large language models typically has a higher degree of accuracy. By leveraging large language models in this manner, more accurate specialized vocabulary can be obtained, thereby enhancing the representation capabilities of these terms in the vocabulary and improving the accuracy of translations.

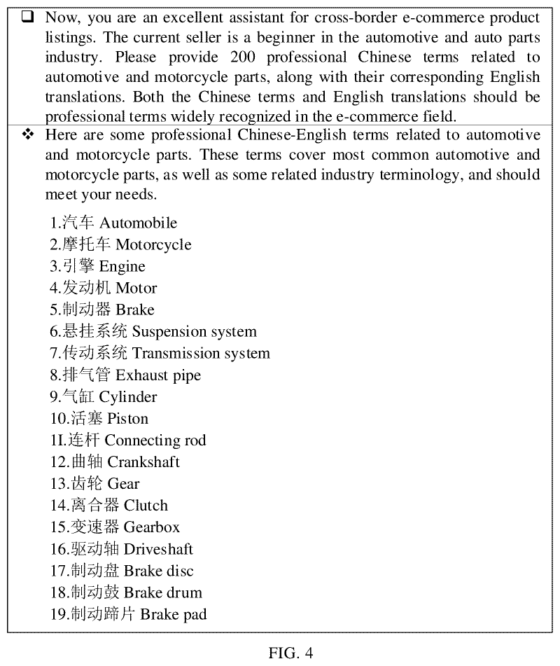

In this embodiment, the “query” refers to a set of questions designed to retrieve specialized vocabulary for the required domain. The query can consist of one or more sentences, without specific limitations. FIG. 4 illustrates the use of an LLM to output specialized vocabulary for a designated domain in another embodiment of this application. As shown in FIG. 4, the query input into the LLM is: “Now, you are an excellent assistant for cross-border e-commerce product listings. The current seller is a beginner in the automotive and auto parts industry. Please provide 200 professional Chinese terms related to automotive and motorcycle parts, along with their corresponding English translations. Both the Chinese terms and English translations should be professional terms widely recognized in the e-commerce field.” The LLM processes this query using natural language processing and outputs the relevant results, providing specialized vocabulary for the required domain.

S303: adjusting the feature vectors in the vocabulary using the specialized vocabulary from the designated domain.

In this embodiment, each word in the vocabulary is associated with a feature vector that represents the semantic understanding of the word, expressed in vector form. The accuracy of these feature vectors reflects the accuracy of translation from the source language to the target language. After obtaining the specialized vocabulary from the LLM, the feature vectors in the vocabulary can be checked for alignment with the specialized vocabulary. If discrepancies are found, the specialized vocabulary is used to modify the feature vectors, thereby optimizing the feature vectors in the vocabulary.

S304: cleaning the open-source dataset using a CL-SSL method to filter and retain corpora with semantic similarity above the threshold.

In one embodiment, step S304 may be replaced by any of the following steps:
using the LASER method to clean the open-source dataset, filtering out corpora with sentence embedding similarity above the threshold;
using the length method to clean the open-source dataset, filtering out corpora where the maximum and minimum sentence length ratios meet the threshold;
using the LID (Language Identification) method to clean the open-source dataset, filtering out corpora that match the source and target languages;
using the Deduplication method to clean the open-source dataset, removing duplicate data to obtain the filtered corpora;
using the retranslation filter method to clean the open-source dataset, filtering out corpora that meet the translation metrics.

In this embodiment, LASER is a method used to generate language-agnostic sentence representations. It maps text sentences into a continuous vector space, enabling semantic similarity comparisons and information retrieval in cross-lingual and cross-task scenarios. The Length method identifies sentences that do not meet the specified maximum and minimum length ratios and filters out sentence pairs with highly skewed length ratios. The LID method is tasked with predicting the primary language of a text segment and is widely used in commercial applications, such as the language detection feature in certain browsers. Once the source and target languages are determined, LID can exclude other languages. Translation filtering is a technique used in machine translation to filter and select translation results based on metrics such as sacreBLEU, ROUGE, or chrF++, ensuring the most accurate translation results are chosen.

The aforementioned methods for cleaning the open-source dataset can filter out low-quality texts from the dataset, generating high-quality corpora. This reduces the risk of ambiguity in translation and further enhances the accuracy of translation results, as well as their adaptability to the e-commerce domain.

S305: training the translation model using the aforementioned corpora with a specified method.

In this embodiment, the specified method may include at least one of the following: contrastive learning, supervised learning, reinforcement learning, semi-supervised learning, weakly supervised learning, or self-supervised learning.

The contrastive learning method is a specialized vocabulary representation enhancement technique that improves the model's ability to represent previously unrecognized words. Specifically, the contrastive learning method can make two inferences using the same model with different regularization techniques, such as dropout, and then calculate the KL similarity between the two inference results. This process enhances the model's robustness against various interference factors.

S306: performing deduplication and optimization of a translation result during the training process using a hybrid deduplication method or a model-based training and prediction deduplication method.

In this embodiment, the hybrid deduplication method may include at least one of the following: repetition Penalty Algorithm, Contrastive Search Algorithm, and Beam Search Algorithm.

The principle of the repetition penalty algorithm is to calculate a repetition penalty factor during inference, which restricts the generation of repeated tokens. The contrastive search algorithm reduces repetition and monotony significantly during the model training and inference phases by limiting the probability of generating similar tokens through contrastive loss and contrastive search in the decoder phase. The beam search algorithm is an improvement over the greedy strategy, where instead of retaining only the highest-scoring output at each time step, it retains the top num_beams outputs. When num_beams=1, beam search degenerates into greedy search. In this embodiment, the preferred approach is to use a combination of these three algorithms for hybrid deduplication, which achieves optimal deduplication results. Specifically, 3-gram repetition was reduced by 99.31%, and the RougeL score improved by 74.48%, effectively eliminating the issue of repetitive translation.

The model-based deduplication method during training and prediction specifically implements deduplication as follows: by suppressing repeated words during training to reduce repetitive input and increasing diversity in generation during prediction to minimize repeated output. In one embodiment, this may include the following steps: fine-tuning at the sentence level using the Unlikelihood Training method; Sampling from the top K tokens in the output logits to select the output token, meaning that with the same input, the results generated through multiple TopK sampling runs are likely to be different, enhancing randomness; controlling the model's hyperparameter “Temperature,” which adjusts the probability distribution in the softmax output layer, thereby controlling the randomness and creativity of the generated text.

The various deduplication processes used during the translation model training significantly reduce the probability of mistranslation and omissions, ensuring translation accuracy.

The translation model training method provided in this embodiment expands the translation model's vocabulary by adding commonly used and specialized vocabulary in advance, optimizes the feature vectors in the vocabulary based on a large language model, and cleans the open-source dataset using data cleansing methods to filter out high-quality corpora. By training the translation model with these corpora, the method not only enhances the vocabulary but also improves the accuracy of the translation model in specialized domain translations.

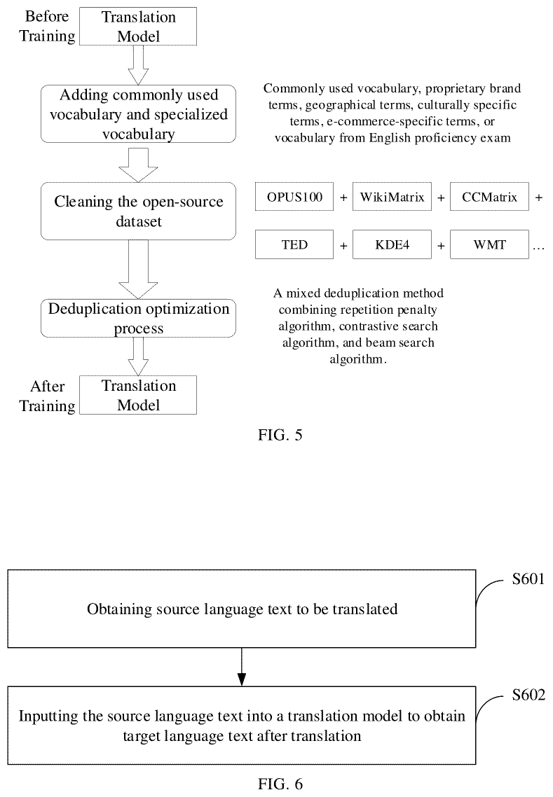

FIG. 5 is a schematic diagram illustrating the translation model training process according to another embodiment of the present application. As shown in FIG. 5, the vocabulary of the translation model is first expanded by adding commonly used vocabulary and specialized vocabulary, including proprietary brand names, geographic terms, culturally specific terms, e-commerce-specific terms, or vocabulary from English proficiency exams, etc. Then, the open-source datasets are cleaned to obtain high-quality corpora that meet the required standards. These open-source datasets may include OPUS100, WikiMatrix, CCMatrix, TED, KDE4, WMT, and others. The translation model is subsequently trained using this cleaned corpus. During the training process, a combination of the repetition penalty algorithm, contrastive search algorithm, and beam search algorithm is applied to remove duplicates. Ultimately, the trained translation model is obtained.

Another embodiment of the present application provides a translation method. FIG. 6 is a flowchart illustrating the translation method according to another embodiment of the present application. The method may include the following steps.

S601: obtaining source language text to be translated.

S602: inputting the source language text into a translation model to obtain target language text after translation.

The translation model used is the one trained through the translation model training method provided in any of the aforementioned embodiments.

In one embodiment, step S601 may include: in the product search scenario of an e-commerce platform, obtaining product information as the source language text to be translated, where the product information includes at least one of a title, keywords, or details from the product page.

In the embodiments of the present application, unlike everyday conversational text, which typically has a complete semantic structure, cross-border e-commerce texts, such as titles, keywords, or product descriptions, often feature keyword stacking and lack a coherent language structure. On one hand, the search terms entered by users are often short and consist mainly of keyword phrases, such as “red dress” or “FY35 multi-head electric drill.” These terms are matched with the product text, and only products with matching keywords will be recalled and ultimately displayed. On the other hand, to increase product exposure under various search terms, sellers often stack trending keywords unrelated to the product in the title. For example, titles like “15*15 paper rose finished DIY handmade Kawasaki folding paper rose flower head birthday gift” or “perforated neoprene waist support logo sports waist belt foreign trade fitness belt slimming waist belt wholesale” illustrate the increasingly severe issue of ignoring word order and keyword stacking in e-commerce text.

Therefore, in order to accurately translate e-commerce texts, the translation model training method in this embodiment overcomes issues such as insufficient semantic understanding of specialized e-commerce terminology, lack of high-quality training samples tailored for e-commerce text expressions, low translation accuracy, attribute omissions, and severe word repetition. This translation method significantly improves translation accuracy in e-commerce scenarios. For example, the e-commerce context contains numerous specialized vocabulary, such as trade terms like “drop shipping,” “custom manufacturing,” and “OEM production,” as well as industry-specific terms like “brushed finish,” “ribbed,” “pullover,” and “blended fabric.” The translation method in this embodiment can accurately comprehend key information in e-commerce texts, achieving precise recognition and translation, thereby helping users better understand the product information being displayed and avoiding transaction losses or customer churn caused by poor translation quality.

The translation method provided in this embodiment translates the source language text into the target language text based on a pre-trained translation model. By using an expanded vocabulary that includes commonly used vocabulary and specialized vocabulary, the accuracy of the translation model in specialized domains is enhanced. In search scenarios, this method not only improves translation accuracy but also boosts search efficiency. Evaluations of title translations on e-commerce platforms have shown significant improvements in offline model metrics, a marked increase in translation quality, and a substantial enhancement in translation-related service performance.

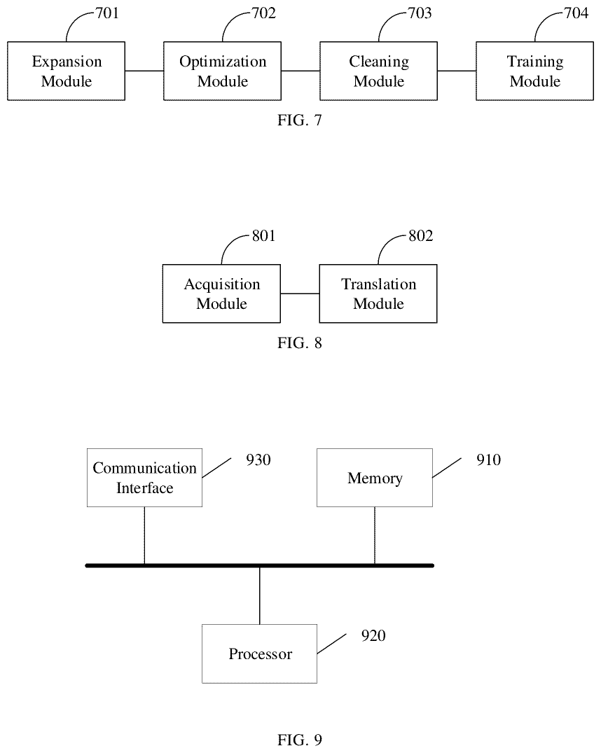

Corresponding to the application scenarios and methods of the translation model training method provided by this embodiment, this application also provides a translation model training device. FIG. 7 shows a structural block diagram of the translation model training device according to one embodiment of the present application. The device may include:
expansion module 701, configured to expand the vocabulary of the translation model by adding commonly used vocabulary and specialized vocabulary in advance;
optimization module 702, configured to optimize the feature vectors in the vocabulary based on a large language model;
cleaning module 703, configured to clean the open-source datasets using data cleaning methods, filtering out corpora that meet the required quality standards;
training module 704, configured to train the translation model using the corpora.

The expanded specialized vocabulary may include at least one of the following: proprietary brand terms, geographic terms, culturally specific terms, e-commerce-specific terms, or vocabulary from English proficiency exams. The large language model may include at least one of the following: BLOOMZ, GPT-4, ChatGLM, LLaMA, OPT, Claude, Qwen, or ERNIE Bot.

In one embodiment, the optimization module 702 may be configured to: input the query into the large language model, and after processing by the large language model, output specialized vocabulary in the specified domain. These specialized vocabulary are then used to adjust the feature vectors in the vocabulary.

In one embodiment, the cleaning module 703 may perform cleaning using at least one of the following methods:
using the CL-SSL method to clean the open-source dataset, filtering out corpora with semantic similarity higher than a threshold;
using the LASER method to clean the open-source dataset, filtering out corpora with sentence embedding similarity higher than a threshold;
using the length method to clean the open-source dataset, filtering out corpora with sentence length ratios that meet the threshold;
using the LID method to clean the open-source dataset, filtering out corpora that conform to the source and target languages;
using the duplicate data removal method to clean the open-source dataset, removing duplicate data to obtain the corpora;
using the translation filtering method to clean the open-source dataset, filtering out corpora that meet translation metrics.

In one embodiment, the training module 704 may be configured to train the translation model using the corpora with a specified method, which may include at least one of the following: contrastive learning, supervised learning, reinforcement learning, semi-supervised learning, weakly supervised learning, or self-supervised learning.

In one embodiment, the device may further include a deduplication module, configured to perform deduplication optimization on the translation results during training using a mixed deduplication method or a deduplication method based on model training and prediction.

The mixed deduplication method may include at least one of the repetition penalty algorithm, contrastive search algorithm, or beam search algorithm. The deduplication method based on model training and prediction specifically reduces duplication by suppressing repeated words during training and enhancing the diversity of generated outputs during prediction to minimize repetitive generation.

The functions of the modules in each device of the embodiments of this application can refer to the corresponding descriptions in the methods mentioned above, and they provide corresponding beneficial effects. Therefore, further details will not be repeated here.

The translation model training device provided in this embodiment expands the vocabulary of the translation model by adding commonly used vocabulary and specialized vocabulary, optimizes the feature vectors in the vocabulary based on a large language model, and cleans the open-source datasets using data cleaning methods to filter out high-quality corpora. The translation model is trained using these corpora, thereby not only expanding the vocabulary of the translation model but also improving its accuracy in specialized domain translations.

Corresponding to the application scenarios and methods of the translation method provided in this embodiment of the present application, this embodiment also provides a translation device. As shown in FIG. 8, which illustrates a structural block diagram of a translation device according to one embodiment of this application, the device may include:
an acquisition module 801, configured to acquire the source language text to be translated;
a translation module 802, configured to input the source language text into the translation model, and perform translation to obtain the target language text;
wherein the translation model is trained using the translation model training method provided in any of the above embodiments.

In one embodiment, the acquisition module 801 may be configured to: in the product search scenario of an e-commerce platform, obtain product information as the source language text to be translated, where the product information may include at least one of the following: title, keywords, or details from the product description page.

The functions of the modules in the devices of this embodiment of the present application can refer to the corresponding descriptions in the aforementioned methods and possess the corresponding beneficial effects, which will not be reiterated here.

The translation device provided in this embodiment translates the source language text into the target language text based on a pre-trained translation model. By utilizing an expanded vocabulary that includes both common and specialized vocabulary, the accuracy of the translation model in specialized domains is enhanced. In search scenarios, this not only improves translation accuracy but also increases search efficiency.

FIG. 9 is a block diagram of an electronic device used to implement the embodiments of this application. As shown in FIG. 9, the electronic device includes: a memory 910 and a processor 920, where the memory 910 stores a computer program that can run on the processor 920. When the processor 920 executes the computer program, it implements any of the methods described in the above embodiments. The quantity of memory 910 and processor 920 can be one or more.

The electronic device further includes: a communication interface 930, configured to communicate with external devices and perform data exchange and transmission.

If the memory 910, processor 920, and communication interface 930 are implemented independently, they can be interconnected and communicate with each other via a bus. The bus may be an Industry Standard Architecture (ISA) bus, Peripheral Component Interconnect (PCI) bus, Extended Industry Standard Architecture (EISA) bus, or other types. The bus may include an address bus, data bus, control bus, etc. For simplicity, only a single bold line is shown in the figure, but this does not imply that there is only one bus or one type of bus.

Alternatively, in specific implementations, if the memory 910, processor 920, and communication interface 930 are integrated into a single chip, they can communicate with each other via internal interfaces.

This embodiment of the present application provides a computer-readable storage medium, which stores a computer program. When executed by a processor, the program implements any of the methods provided in the embodiments of this application.

This embodiment of the present application also provides a chip, which includes a processor configured to retrieve and execute instructions stored in the memory, enabling the communication device equipped with the chip to execute any of the methods provided in the embodiments of this application.

This embodiment of the present application also provides a chip, which includes: an input interface, an output interface, a processor, and a memory. The input interface, output interface, processor, and memory are interconnected through internal connection pathways. The processor is configured to execute the code stored in the memory, and when the code is executed, the processor carries out any of the methods provided in the embodiments of this application.

It should be understood that the processor mentioned above can be a Central Processing Unit (CPU), or it may be another general-purpose processor, a Digital Signal Processor (DSP), an Application Specific Integrated Circuit (ASIC), a Field Programmable Gate Array (FPGA), or other programmable logic devices, discrete gate or transistor logic devices, discrete hardware components, etc. The general-purpose processor can be a microprocessor or any conventional processor. Notably, the processor can also be one that supports the Advanced RISC Machines (ARM) architecture.

Furthermore, optionally, the memory mentioned above may include both read-only memory and random access memory. The memory can be volatile or non-volatile, or it may include both volatile and non-volatile memory. Non-volatile memory may include Read-Only Memory (ROM), Programmable ROM (PROM), Erasable PROM (EPROM), Electrically EPROM (EEPROM), or flash memory. Volatile memory may include Random Access Memory (RAM), which serves as external high-speed cache. By way of exemplary but non-limiting illustration, various forms of RAM may be used. For instance, Static RAM (SRAM), Dynamic RAM (DRAM), Synchronous DRAM (SDRAM), Double Data Rate SDRAM (DDR SDRAM), Enhanced SDRAM (ESDRAM), Sync Link DRAM (SLDRAM), and Direct Rambus RAM (DR RAM).

In the above embodiments, the implementation can be entirely or partially through software, hardware, firmware, or any combination thereof. When implemented using software, it can be wholly or partially realized in the form of a computer program product. The computer program product includes one or more computer instructions, which, when loaded and executed on a computer, generate all or part of the processes or functions according to this application. The computer can be a general-purpose computer, a specialized computer, a computer network, or other programmable devices. The computer instructions can be stored in a computer-readable storage medium or transmitted from one computer-readable storage medium to another.

In the description of this specification, references to terms such as “one embodiment,” “some embodiments,” “example,” “specific example,” or “some examples” mean that specific features, structures, materials, or characteristics described in connection with that embodiment or example are included in at least one embodiment or example of the present application. Moreover, the specific features, structures, materials, or characteristics described may be combined in any suitable way in one or more embodiments or examples. Furthermore, unless otherwise contradicted, a person skilled in the art may combine and integrate the different embodiments or examples and features of the various embodiments or examples described in this specification.

Furthermore, the terms “first” and “second” are used solely for descriptive purposes and should not be understood as indicating or implying relative importance, nor as implicitly specifying the quantity of the referenced technical features. Thus, features described as “first” or “second” may explicitly or implicitly include at least one of those features. In the description of this application, the term “multiple” means two or more, unless otherwise explicitly defined.

Any process or method described in the flowcharts or otherwise described herein may be understood as representing a module, segment, or portion of executable instructions that include one or more steps to implement specific logical functions or processes. Moreover, the scope of the preferred embodiments of this application includes alternative implementations, in which functions may be executed in a different order than shown or discussed, including in a substantially simultaneous manner or in reverse order, depending on the functionality involved.

The logic and/or steps described in the flowcharts or otherwise described herein can be considered as sequencing lists of executable instructions for implementing logical functions. These may be specifically implemented in any computer-readable medium for use by or in conjunction with an instruction execution system, device, or apparatus (such as a computer-based system, a system including a processor, or any other system capable of fetching and executing instructions from an instruction execution system, device, or apparatus).

It should be understood that various parts of this application may be implemented in hardware, software, firmware, or a combination thereof. In the above embodiments, multiple steps or methods may be implemented through software or firmware stored in memory and executed by a suitable instruction execution system. All or part of the steps of the method in the above embodiments can be instructed to be performed by relevant hardware via a program, which can be stored in a computer-readable storage medium. When executed, the program includes one or more of the steps of the method embodiments, or a combination thereof.

Furthermore, the functional units in each embodiment of this application can be integrated into a single processing module, or they may exist as separate physical units, or two or more units can be integrated into one module. The integrated module can be implemented in the form of hardware or as a software functional module. If the integrated module is implemented as a software functional module and sold or used as an independent product, it can also be stored in a computer-readable storage medium. This storage medium may be a read-only memory, magnetic disk, optical disk, or similar media.

It should be noted that the embodiments of this application may involve the use of user data. In practical applications, user-specific personal data may be used in the solutions described herein within the scope permitted by applicable laws and regulations, provided that the applicable legal requirements of the respective country are met (for example, through explicit user consent, proper user notification, etc.).

The above descriptions are merely exemplary embodiments of this application, and the scope of protection of this application is not limited thereto. Any variations or substitutions that can be easily conceived by those skilled in the art within the technical scope disclosed in this application should be included within the scope of protection. Therefore, the protection scope of this application should be defined by the claims.

What is claimed is:

1. A method for training a translation model, comprising:
expanding vocabulary of the translation model with commonly used vocabulary and specialized vocabulary in advance;
optimizing feature vectors in the vocabulary based on a large language model;
cleaning an open-source dataset using a data cleaning method to filter and retain corpora meeting a quality standard; and
training the translation model using the corpora.

2. The method according to claim 1, wherein optimizing the feature vectors in the vocabulary based on a large language model comprises:
inputting a query into the large language model, wherein the large language model processes the query and outputs specialized vocabulary for a designated domain; and
adjusting the feature vectors in the vocabulary using the specialized vocabulary for the designated domain.

3. The method according to claim 1, wherein cleaning an open-source dataset using a data cleaning method to filter and retain corpora meeting a quality standard comprises at least one of the following:
cleaning the open-source dataset using a cross-lingual similarity learning (CL-SSL) method to filter corpora with a semantic similarity exceeding a threshold;
cleaning the open-source dataset using a language-agnostic sentence representation (LASER) method to filter corpora with a sentence embedding similarity exceeding a threshold;
cleaning the open-source dataset using a length-based method to filter corpora where a maximum-to-minimum sentence length ratio meets a threshold;
cleaning the open-source dataset using a language identification (LID) method to filter corpora that match source and target languages;
cleaning the open-source dataset by removing duplicate data to filter corpora; or
cleaning the open-source dataset using a translation filtering method to filter corpora that meet a translation quality metric.

4. The method according to claim 1, wherein training the translation model using the corpora comprises:
using the corpora to train the translation model with at least one specified method, the specified method comprising at least one of contrastive learning, supervised learning, reinforcement learning, semi-supervised learning, weakly supervised learning, or self-supervised learning.

5. The method according to claim 1, further comprising:
performing deduplication optimization of a translation result during the training process using a hybrid deduplication method or a model-based training and prediction deduplication method.

6. The method according to claim 5, wherein the hybrid deduplication method comprises at least one of a repetition penalty algorithm, a contrastive search algorithm, or a beam search algorithm.

7. The method according to claim 1, wherein expanded specialized vocabulary comprises at least one of proprietary brand vocabulary, geographic vocabulary, culturally-specific vocabulary, e-commerce-specific vocabulary, or English examination vocabulary.

8. The method according to claim 1, further comprising:
obtaining source language text to be translated;
inputting the source language text into the translation model to obtain target language text after translation.

9. The method according to claim 8, wherein obtaining the source language text to be translated comprises:
obtaining product information as the source language text in a product search scenario on an e-commerce platform, wherein the product information includes at least one of a title, a keyword, or details from a product description page.

10. A non-transitory computer-readable storage medium configured with instructions executable by one or more processors to cause the one or more processors to perform operations comprising:
expanding vocabulary of the translation model with commonly used vocabulary and specialized vocabulary in advance;
optimizing feature vectors in the vocabulary based on a large language model;
cleaning an open-source dataset using a data cleaning method to filter and retain corpora meeting a quality standard; and
training the translation model using the corpora.

11. The non-transitory computer-readable storage medium according to claim 10, wherein optimizing the feature vectors in the vocabulary based on a large language model comprises:
inputting a query into the large language model, wherein the large language model processes the query and outputs specialized vocabulary for a designated domain; and
adjusting the feature vectors in the vocabulary using the specialized vocabulary for the designated domain.

12. The non-transitory computer-readable storage medium according to claim 10, wherein cleaning an open-source dataset using a data cleaning method to filter and retain corpora meeting a quality standard comprises at least one of the following:
cleaning the open-source dataset using a cross-lingual similarity learning (CL-SSL) method to filter corpora with a semantic similarity exceeding a threshold;
cleaning the open-source dataset using a language-agnostic sentence representation (LASER) method to filter corpora with a sentence embedding similarity exceeding a threshold;
cleaning the open-source dataset using a length-based method to filter corpora where a maximum-to-minimum sentence length ratio meets a threshold;
cleaning the open-source dataset using a language identification (LID) method to filter corpora that match source and target languages;
cleaning the open-source dataset by removing duplicate data to filter corpora; or
cleaning the open-source dataset using a translation filtering method to filter corpora that meet a translation quality metric.

13. The non-transitory computer-readable storage medium according to claim 10, wherein training the translation model using the corpora comprises:
using the corpora to train the translation model with at least one specified method, the specified method comprising at least one of contrastive learning, supervised learning, reinforcement learning, semi-supervised learning, weakly supervised learning, or self-supervised learning.

14. The non-transitory computer-readable storage medium according to claim 10, wherein the operations further comprises:
performing deduplication optimization of a translation result during the training process using a hybrid deduplication method or a model-based training and prediction deduplication method.

15. The non-transitory computer-readable storage medium according to claim 14, wherein the hybrid deduplication method comprises at least one of a repetition penalty algorithm, a contrastive search algorithm, or a beam search algorithm.

16. The non-transitory computer-readable storage medium according to claim 10, wherein expanded specialized vocabulary comprises at least one of proprietary brand vocabulary, geographic vocabulary, culturally-specific vocabulary, e-commerce-specific vocabulary, or English examination vocabulary.

17. The non-transitory computer-readable storage medium according to claim 10, wherein the operations further comprises:
obtaining source language text to be translated;
inputting the source language text into the translation model to obtain target language text after translation.

18. The non-transitory computer-readable storage medium according to claim 17, wherein obtaining the source language text to be translated comprises:
obtaining product information as the source language text in a product search scenario on an e-commerce platform, wherein the product information includes at least one of a title, a keyword, or details from a product description page.

19. An electronic device comprising:
one or more processors; and
one or more computer-readable memories coupled to the one or more processors and having instructions stored thereon that are executable by the one or more processors to perform one or more operations comprising:
expanding vocabulary of the translation model with commonly used vocabulary and specialized vocabulary in advance;
optimizing feature vectors in the vocabulary based on a large language model;
cleaning an open-source dataset using a data cleaning method to filter and retain corpora meeting a quality standard; and
training the translation model using the corpora.

20. The electronic device according to claim 19, wherein optimizing the feature vectors in the vocabulary based on a large language model comprises:
inputting a query into the large language model, wherein the large language model processes the query and outputs specialized vocabulary for a designated domain; and
adjusting the feature vectors in the vocabulary using the specialized vocabulary for the designated domain.
